(19) United States
(12) Patent Application Publication
(10) Pub. No.: US 2024/0127466 A1
(43) Pub. Date: Apr. 18, 2024

(54) ENERGY-EFFICIENT POINT CLOUD FEATURE EXTRACTION METHOD BASED ON FIELD-PROGRAMMABLE GATE ARRAY (FPGA) AND APPLICATION THEREOF

(71) Applicant: SHANGHAITECH UNIVERSITY, Shanghai (CN)

(72) Inventors: Hao SUN, Shanghai (CN); Yajun HA, Shanghai (CN)

(73) Assignee: SHANGHAITECH UNIVERSITY, Shanghai (CN)

(21) Appl. No.: 18/369,884

(22) Filed: Sep. 19, 2023

Related U.S. Application Data
(63) Continuation of application No. PCT/CN2022/134241, filed on Nov. 25, 2022.

(30) Foreign Application Priority Data
Oct. 13, 2022 (CN) 202211251084.7

(51) Int. Cl. G06T 7/521; G06F 18/2135

(52) U.S. Cl. CPC G06T 7/521; G06F 18/2135; G06T 2207/10028

(57) ABSTRACT

An energy-efficient point cloud feature extraction method based on a field-programmable gate array (FPGA) is mapped onto the FPGA for running. The energy-efficient point cloud feature extraction method based on the FPGA is applied to point cloud feature extraction in unmanned driving; or an intelligent robot. Compared with an existing technical solution, the energy-efficient point cloud feature extraction method based on the FPGA has following innovative points: a low-complexity projection method for organizing unordered and sparse point clouds, a high-parallel method for extracting a coarse-grained feature point, and a high-parallel method for selecting a fine-grained feature point.

### CROSS REFERENCE TO THE RELATED APPLICATIONS

This application is the continuation application of International Application No. PCT/CN2022/134241, filed on Nov. 25, 2022, which is based upon and claims priority to Chinese Patent Application No. 202211251084.7, filed on Oct. 13, 2022, the entire contents of which are incorporated herein by reference.

### TECHNICAL FIELD

The present disclosure relates to a point cloud feature extraction algorithm and an application thereof.

### BACKGROUND

A point cloud feature extraction algorithm extracts features (such as the contour, corner point, and plane point) from every frame of point cloud data generated by LiDAR for subsequent calculation, and is widely used in the fields of unmanned driving and intelligent robots. The point cloud feature extraction is intended to filter out noise in the original point cloud to improve accuracy of subsequent positioning and mapping, and to remove redundant points to improve the running speed of subsequent operations.

However, for a LiDAR wire harness that has been upgraded to 128 wires and a scanning speed increased to 20 Hz, the processing time of a traditional feature extraction algorithm is greatly increased. On an edge computing processor, a current most advanced point cloud feature extraction algorithm can only achieve a processing speed lower than 9 Hz, which is far lower than the real-time requirement. In addition, there is a constraint on the power consumption of the application in an intelligent vehicle. Therefore, it is highly desirable to develop a real-time and energy-efficient feature extraction algorithm.

In order to resolve this problem, relevant experts have made explorations in different aspects. [1] In a series of works, the geometric feature point is calculated by calculating a local curvature of each point, which is complex and cannot efficiently process a large quantity of point clouds. [2] in another series of works, a three-dimensional (3D) point cloud is mapped onto a two-dimensional (2D) areal map or an aerial view, and then a feature is extracted using an image similarity method. In this way, the processing speed has been increased significantly, but the fact that the wire harness of the LiDAR is unevenly emitted in the vertical direction results in low feature accuracy. [3] By developing parallelism of the graphics processing unit (GPU), a method for fast extraction of a 2D feature point is proposed, with a processing speed of 300 frames per second. However, the GPU consumes a large amount of electricity, which greatly affects the endurance capacity of an intelligent vehicle. [4] A high-performance and low-power consumption feature extraction algorithm has been implemented on an FPGA platform, but it can only process 2D image data.

### CITED REFERENCES

[1] J. Zhang and S. Singh, “Low-drift and real-time LiDaR. odometry and mapping,” Auton. Robots, vol. 41, no. 2, pp. 401-416, Feb. 2017.

[2] N. Attarmoghaddam and K. F. Li, “An area-efficient FPGA implementation of a real-time multi-class classifier for binary images,” IEEE Trans. Circuits Syst. II, Exp. Briefs, vol. 69, no. 4, pp. 2306-2310, Apr. 2022.

[3] B. Nagy, P. Foehn, and D. Scaramuzza, “Faster than FAST: GPU-accelerated frontend for high-speed VIO,” in Proc. IEEE/RSJ Int. Conf. Intell. Robots Syst. (IROS), Oct. 2020, pp. 4361-4368.

[4] Y. Liu et al., “MobileSP: An FPGA-based real-time keypoint extraction hardware accelerator for mobile VSLAM,” IEEE Trans, Circuits Syst, I, Reg. Papers, early access, Jul. 21, 2022, doi: 10.1109/TCSI.2022.3190300.

### SUMMARY

The present disclosure is intended to resolve a technical problem that on an edge computing processor, a current most advanced point cloud feature extraction algorithm can only achieve a processing speed lower than 9 Hz, far lower than a real-time requirement.

In order to resolve the above technical problem, a technical solution of the present disclosure provides an energy-efficient point cloud feature extraction method based on an FPGA, which is mapped onto the FPGA for running and includes following steps:
step 1: obtaining an unordered point cloud, and for a point (x, y, z) in the unordered point cloud, accurately projecting the point into a point cloud matrix by using a laser angle guided projection method, which includes following steps:
step 101: constructing a median laser emission angle look-up table for a LiDAR, and. recording a median angle ϕₙ of adjacent emission angles of the LiDAR in the median laser emission angle look-up table, where ϕₙ=(ωₙ+ωₙ₊₁)/2, ωₙ represents an emission angle of an n^{th} laser wire harness emitted by the LiDAR, n∈[0N−1], and the LiDAR emits a total of N laser wire harnesses;
step 102: multiplying a square of a tangent value of each median angle recorded in the median laser emission angle look-up table by a positive or negative coefficient, and constructing a wire harness look-up table τ, where for each median angle φₙ, a corresponding wire harness look-up value τₙ is calculated according to a following formula:

τₙ=sign(ϕₙ)×(tan(ϕₙ))²,
where sign(ϕₙ) represents a positive or negative sign of ϕₙ;
step 103: obtaining a corresponding look-up value τₚ of each point (x, y, z) in the unordered point cloud according toτₚ=sign(z)×(z²/(x²+y²)) , comparing the look-up value τₚ and the wire harness look-up table to obtain a laser wire harness of each point to further obtain a row index v in the point cloud matrix, and projecting a current point into the point cloud matrix in combination with a column index h of the current point; and
step 104: repeating the step 103 until all points in the unordered point cloud are traversed, to obtain the point cloud matrix;
step 2: dividing elements in the point cloud matrix into three categories: a start element, a lost element, and a normal element, where the lost element is an element corresponding to a position onto which no point is mapped, the normal element is an element onto which a point is mapped, and the start element is an element belonging to a 0^{th} row or a normal element in a row next to the lost element; and
performing column-scanning to traverse the point cloud matrix to detect a coarse-grained feature point, which includes following steps:
step 201: calculating a local plane curvature of each data point in each point cloud matrix and filtering out an unreliable data point or a blocking point, where
for a reliable data point, a data point whose local plane curvature c exceeds a corner point threshold t_{edge} is marked as a coarse-grained corner point, and for a data point whose local plane curvature c is less than a plane point threshold tₚₗₐₙₑ, step 202 is performed for processing;
step 202: calculating a slope θ of a data point obtained in the previous step, marking a data point whose slope θ is greater than a threshold tᵥₚ as a coarse-grained vertical plane point, and performing step 203 to process a data point whose slope θ is less than a threshold t_{θ};
step 203: introducing a global average ground point height h_{g} and a local average ground point height hₗ, where the global average ground point height h_{g} represents an average height of all currently calculated ground points, and the local average ground point height hₗ represents an average height of ground points within a local range of a currently processed point; and
for the data point whose slope θ is less than the threshold t_{θ}:
if the data point is the start element, calculating an absolute value of a difference between a height value of the data point and the global average ground point height h_{g}, and marking a data point with an absolute value less than a global height difference threshold t_{hg} as a coarse-grained ground point; and
if the data point is the normal element, calculating an absolute value of a difference between a height value of the data point and the global average ground point height h_{g}, calculating a difference between the height value of the data point and the local average ground point height hₗ, and marking a data point as a coarse-grained ground point when an absolute value of a difference between a height value of the data point and the global average ground point height h_{g} is less than a global height difference threshold t_{hg} and a difference between the height value of the data point and the local average ground point height hₗ is within a threshold range; and
step 204: collectively defining the obtained coarse-grained ground point and coarse-grained vertical plane point as a coarse-grained plane point, and obtaining the coarse-grained feature point including the coarse-grained plane point and the coarse-grained corner point; and
step 3: gradually and evenly selecting a fine-grained feature point from the coarse-grained feature point.

Preferably, in the step 103, the column index h is calculatedaccording to a following formula:

$$h = arctan ( \frac{y}{x} ) / Δα ,$$

where Δα represents resolution of a rotation angle of the LiDAR.

Preferably, in the step 201, a local plane curvature c of an i^{th} data point pᵢ in the point cloud matrix is calculated according to a following formula:

$$c = \frac{1}{\vert S \vert ‖ {p}_{i} ‖} ‖ {Σ}_{j ∈ S , j \neq i} ( {p}_{i} - {p}_{j} ) ‖ ,$$

where S represents a set of consecutive points adjacent to the pᵢ in a same row in the point cloud matrix.

Preferably, in the step 201, the unreliable data point or the blocking point is filtered out by calculating a depth distance difference between each data point and an adjacent point.

Preferably, in the step 202, the slope θ is obtained by dividing a square of a distance difference between a current data point and a next laser wire harness in a z direction by a square of a horizontal projection distance between two points, and if a slope of a data point (x_{(i,j)}y_{(i,j)}, z_{(i,j)}) in a position (i,j) in the point cloud matrix is θ_{(i,j)}, then

$${θ}_{( i , j )} = \frac{{( {x}_{( i + 1 , j )} - {z}_{( i , j )} )}^{2}}{{( {x}_{( i + 1 , j )} - {x}_{( i , j )} )}^{2} + {( {y}_{( i + 1 , j )} - {y}_{( i , j )} )}^{2}} .$$

Preferably, in the step 3, a plane point priority queue and a corner point priority queue are established based on the coarse-grained plane point and the coarse-grained corner point respectively, and elements in the plane point priority queue and the corner point priority queue form the fine-grained feature point, where

if nₑ fine-grained feature corner points are required, nₑ elements are stored in the corner point priority queue, the coarse-grained corner point is arranged in the corner point priority queue by curvature in a descending order, and elements whose column index difference is less than a preset value are not allowed to coexist in the corner point priority queue; and

if nₚ fine-grained plane points are required, nₚ elements are stored in the plane point priority queue, the coarse-grained plane point is arranged in the plane point priority queue by curvature in an ascending order, and elements whose column index difference is less than the preset value are not allowed to coexist in the plane point priority queue.

Another technical solution of the present disclosure provides an application of the aforementioned energy-efficient point cloud feature extraction method based on an FPGA, which is applied to point cloud feature extraction in unmanned driving or an intelligent robot.

Compared with an existing technical solution, the present disclosure has following innovative points:
1) A low-complexity projection method for organizing unordered and sparse point clouds
The present disclosure proposes a laser angle guided projection method to accurately project a point into a point cloud matrix, and proposes a look-up table method to reduce algorithm complexity. In addition, the present disclosure also implements a column-scanning scheduler and a progressive refresh strategy based on a dynamically adjustable input to ensure high-performance operation of a hardware pipeline of an FPGA.
2) A high-parallel method for extracting a coarse-grained feature point
Based on a well-organized point cloud matrix, the present disclosure proposes a low-complexity method based on column-scanning and local search to extract a coarse-grained plane point and feature corner point in a streaming manner. In addition, the present disclosure optimizes logic therein, eliminates a data dependency, and improves implementation performance on the FPGA.
3) A high-parallel method for selecting a fine-grained feature point
The present disclosure proposes a high-parallel conditional priority queue to merge the sort operation and conditional selection operation. The present disclosure utilizes the consistency and continuity of the point cloud matrix to progressively and evenly select the fine-grain feature points from the previous coarse-grain feature points. This can significantly reduce the run-time and computational resources.

### BRIEF DESCRIPTION OF THE DRAWINGS

FIG. 1 is a schematic flowchart of a point cloud feature extraction method according to the present disclosure, and is also a diagram of a hardware architecture; and

FIG. 2 is a schematic diagram of ground detection.

### DETAILED DESCRIPTION OF THE EMBODIMENTS

The present disclosure will be further described below with reference to specific embodiments. It should be understood that these embodiments are only intended to describe the present disclosure, rather than to limit the scope of the present disclosure. In addition, it should be understood that various changes and modifications may be made on the present disclosure by those skilled in the art after reading the content of the present disclosure, and these equivalent forms also fall within the scope defined by the appended claims of the present disclosure.

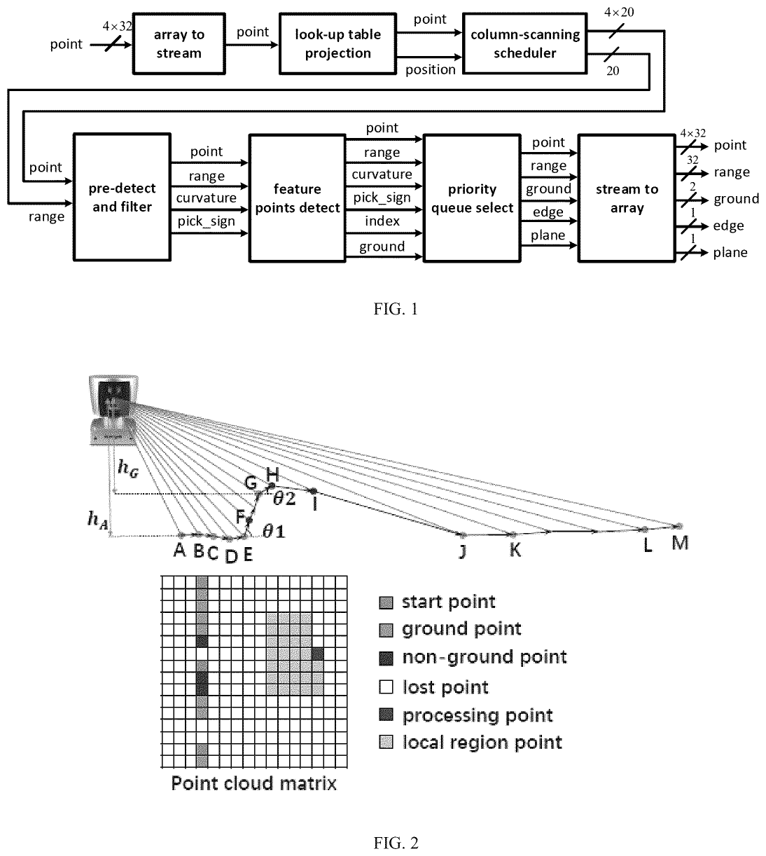

An embodiment provides an energ-efficient point cloud feature extraction method based on an FPGA, which has been fully mapped onto the FPGA for efficient running. An overall block diagram is shown in FIG. 1, and a specific process is as follows:

Step 1: For point (x, y, z) in an unordered point cloud, the point is accurately projected into a point cloud matrix by using a laser angle guided projection method, which includes following steps:

Step 101: A median laser emission angle look-up table is constructed for a LiDAR, and median angle ϕₙ of adjacent emission angles of the LiDAR is recorded in the median laser emission angle look-up table, where ϕₙ=(ωₙ+ωₙ₊₁)/2, ωₙ represents an emission angle of an n^{th} laser wire harness emitted by the LiDAR, n∈[0, N−1], and the LiDAR emits a total of N laser wire harnesses.

Step 102: A square of a tangent value of each median angle recorded in the median laser emission angle look-up table is multiplied by a positive or negative coefficient, and wire harness look-up table τ is constructed. For each median angle ϕₙ, corresponding wire harness look-up value τₙ is calculated according to a following formula:

τₙ=sign(ϕₙ)×(tan (ϕₙ))²,

where sign(ϕₙ) represents a positive or negative sign of ϕₙ.

Step 103: Corresponding look-up value τₚ of each point (x, y, z) in the unordered point cloud is obtained according to τₚ=sign(z)×(z²/(x²+y²)) , the look-up value τₚ and the wire harness look-up table are compared to obtain a laser wire harness of each point, and a row index v in the point cloud matrix is further obtained. Compared with a method described in formula (2) in reference [2], this method can significantly reduce computational complexity while improving projection accuracy.

Step 104: Column index h is obtained according to formula

$$h = arctan ( \frac{y}{x} ) / Δα ,$$

where Δα represents resolution of a rotation angle of the LiDAR. After the row index v and the column index h that are corresponding to each point (x, y, z) are obtained, the point (x, y, z) is projected into position (v,h) in the point cloud matrix.

Step 105: The step 103 and the step 104 are repeated until all points in the unordered point cloud are traversed, to obtain the point cloud matrix.

The step 101 and the step 102 are preprocessing for different LiDARs. To efficiently implement the step 103 to the step 105 on the FPGA, the present disclosure also designs a column-scanning scheduler with a dynamically adjustable input. The column-scanning scheduler dynamically controls an input based on a column index difference between input point cloud matrix data and output data, so as to efficiently implement this projection algorithm in a pipeline manner with a small memory.

The column-scanning scheduler performs column-scanning to traverse the point cloud matrix to detect a coarse-grained feature plane point and feature corner point. The present disclosure divides elements in the point cloud matrix into three categories: a start element, a lost element, and a normal element. The lost element is an element corresponding to a position onto which no point is mapped, the normal element is an element onto which a point is mapped, and the start element is an element belonging to a 0^{th} row or a normal element in a row next to the lost element.

A coarse-grained detection process includes following steps:
Step 201: Local plane curvature c of each data point in each point cloud matrix is calculated according to a following formula:

$$c = \frac{1}{\vert S \vert ‖ {p}_{i} ‖} ‖ {Σ}_{j ∈ S , j \neq i} ( {p}_{i} - {p}_{j} ) ‖ ,$$

where pᵢ represents an i^{th} data point in the point cloud matrix, and S represents a set of consecutive points adjacent to the pᵢ in a same row in the point cloud matrix.
In addition, the unreliable data point or the blocking point is filtered out by calculating a depth distance difference between each data point and an adjacent point.
For a reliable data point, a data point whose local plane curvature c exceeds corner point threshold t_{edge} is marked as a coarse-grained corner point, and for a data point whose local plane curvature c is less than plane point threshold tₚₗₐₙₑ, step 202 is performed for processing.
Step 202: Slope θ of a data point obtained in the previous step is calculated. The slope θ is obtained by dividing a square of a distance difference between a current data point and a next laser wire harness in a z direction by a square of a horizontal projection distance between two points. If a slope of data point (x_{(i,j)}y_{(i,j)}, z_{(i,j)}) in position (i,j) in the point cloud matrix is θ_{(i,j)}.

$${θ}_{( i , j )} = \frac{{( {x}_{( i + 1 , j )} - {z}_{( i , j )} )}^{2}}{{( {x}_{( i + 1 , j )} - {x}_{( i , j )} )}^{2} + {( {y}_{( i + 1 , j )} - {y}_{( i , j )} )}^{2}}$$

A data point whose slope θ is greater than threshold tᵥₚ is marked as a coarse-grained vertical plane point, and step 203 is performed to process a data point whose slope θ is less than threshold t_{θ}.
Step 203: Global average ground point height h_{g} and local average ground point height hₗ are introduced. The global average ground point height h_{g} represents an average height of all currently calculated ground points, and the local average ground point height hₗ represents an average height of ground points within a local range of a currently processed point. The local range is tentatively designated as a 7*7 square array, such as a region represented by a local region point in FIG. 2.
For the data point whose slope θ is less than the threshold t_{θ}:
if the data point is the start element, an absolute value of a difference between a height value of the data point and the global average ground point height h_{g} is calculated, and a data point with an absolute value less than global height difference threshold t_{hg} is marked as a coarse-grained ground point; and
if the data point is the normal element, an absolute value of a difference between a height value of the data point and the global average ground point height h_{g} is calculated, a difference between the height value of the data point and the local average ground point height hₗ is calculated, and a data point is marked as a coarse-grained ground point when an absolute value of a difference between a height value of the data point and the global average ground point height h_{g} is less than global height difference threshold t_{hg} and a difference between the height value of the data point and local average ground point height hₗ is within a threshold range.
Step 204: The obtained coarse-grained ground point and coarse-grained vertical plane point are collectively defined as a coarse-grained plane point, and the coarse-grained feature point including the coarse-grained plane point and the coarse-grained corner point is obtained.
A fine-grained feature point is selected gradually and evenly from the coarse-grained feature point. Unlike an existing method of sorting all points by curvature before selecting them, the present disclosure designs a condition selection priority queue to quickly select a fine-grained point. A length of the priority queue depends on the algorithm, and quantities of required. fine-grained feature corner points and fine-grained plane points are marked as nₑ and nₚ respectively. The fine-grained feature corner point is taken as an example. The present disclosure sets two conditions for the priority queue. A first condition is that the priority queue is arranged by curvature in a descending order, and a second condition is that elements whose column index difference is less than 5 cannot coexist in the priority queue. The first condition ensures successiveness of the priority queue, while the second condition ensures that feature points are aggregated and can be selected evenly. Specific steps were as follows:
Step 301: A curvature and a column index of each to-be-processed coarse-grained corner point are separately compared with a curvature and a column index of each element in a corner point priority queue to obtain a corresponding flag bit array.
Step 302: An operation of each element in the corner point priority queue is determined based on the flag bit array. There are a total of three types of operations, namely keeping unchanged, shifting, and insertion.
Step 303: The corner point priority queue is updated. In the corner point priority queue, a to-be-shifted element is right shifted by one element, and a to-be-processed element is inserted into a position with an insertion flag in the corner point priority queue.
Step 304: All coarse-grained corner points are traversed. In this way, an element retained in the corner point priority queue is the selected fine-grained feature corner point.

A method for selecting the fine-grained plane point is the same as the method for selecting the corner point, but a plane point priority queue is arranged by curvature in an ascending order. The fine-grained feature point is ultimately constituted by elements in the corner point priority queue and the plane point priority queue.

The present disclosure can be applied to point cloud feature extraction in unmanned driving or a robot, and the point cloud may be composed of data from the LiDAR. For different types of LiDARs, the present disclosure can accurately and quickly complete a task of extracting a point cloud feature. Acceleration of the FPGA makes the entire algorithm to have better real-time performance and consume less energy.

What is claimed is:

1. An energy-efficient point cloud feature extraction method based on a field-programmable gate array (FPGA), mapped onto the FPGA for running, and comprising following steps:
step 1: obtaining an unordered point cloud, and for each point (x, y, z) in the unordered point cloud, accurately projecting the point into a point cloud matrix by using a laser angle guided projection method, which comprises following steps:
step 101: constructing a median laser emission angle look-up table for a LiDAR, and recording a median angle ϕₙ of adjacent emission angles of the LiDAR in the median laser emission angle look-up table, where ϕₙ=(ωₙ+ωₙ₊₁)/2, ωₙ represents an emission angle of an n^{th} laser wire harness emitted by the LiDAR, n∈[0N−1], and the LiDAR emits a total of N laser wire harnesses;
step 102: multiplying a square of a tangent value of each median angle recorded in the median laser emission angle look-up table by a positive or negative coefficient to obtain a look-up value τₙ of each wire harness, and then constructing a wire harness look-up table as follows:
τₙ=sign(ϕₙ)×(tan(ϕₙ))²,
where sign(ϕₙ) represents a positive or negative sign of ϕₙ;
step 103: obtaining a corresponding look-up value τₚ of each point (x, y, z) in the unordered point cloud according to τₚ=sign(z)×(z²/(x²+y²)) , comparing the look-up value τₚ and the wire harness look-up table to obtain a laser wire harness of each point to further obtain a row index v in the point cloud matrix, and projecting a current point into the point cloud matrix in combination with a column index h of the current point; and
step 104: repeating the step 103 until all points in the unordered point cloud are traversed, to obtain the point cloud matrix;
step 2: dividing elements in the point cloud matrix into three categories: a start element, a lost element, and a normal element, wherein the lost element is an element corresponding to a position onto which no point is mapped, the normal element is an element onto which a point is mapped, and the start element is an element belonging to a Oth row or a normal element in a row next to the lost element; and
performing column-scanning to traverse the point cloud matrix to detect a coarse-grained feature point, which comprises following steps:
step 201: calculating a local plane curvature of each data point in each point cloud matrix and filtering out an unreliable data point or a blocking point, wherein
for a reliable data point, a data point whose local plane curvature c exceeds a corner point threshold t_{edge} is marked as a coarse-grained corner point, and for a data point whose local plane curvature c is less than a plane point threshold tₚₗₐₙₑ, step 202 is performed for processing;
step 202: calculating a slope θ of a data point obtained in the previous step, marking a data point whose slope θ is greater than a threshold tᵥₚ as a coarse-grained vertical plane point, and performing step 203 to process a data point whose slope θ is less than a threshold t_{θ};
step 203: introducing a global average ground point height h_{g} and a local average ground point height hₗ, wherein the global average ground point height h_{g} represents an average height of all currently calculated ground points, and the local average ground point height hₗ represents an average height of ground points within a local range of a currently processed point; and
for the data point whose slope θ is less than the threshold t_{θ}:
when the data point is the start element, calculating an absolute value of a difference between a height value of the data point and the global average ground point height h_{g}, and marking a data point with an absolute value less than a global height difference threshold t_{hg} as a coarse-grained ground point; and
when the data point is the normal element, calculating an absolute value of a difference between a height value of the data point and the global average ground point height h_{g}, calculating a difference between the height value of the data point and the local average ground point height hₗ, and marking a data point as a coarse-grained ground point when an absolute value of a difference between a height value of the data point and the global average ground point height h_{g} is less than a global height difference threshold t_{hg} and a difference between the height value of the data point and the local average ground point height hₗ is within a threshold range; and
step 204: collectively defining the coarse-grained ground point and the coarse-grained vertical plane point as a coarse-grained plane point, and obtaining the coarse-grained feature point comprising the coarse-grained plane point and the coarse-grained corner point; and
step 3: gradually and evenly selecting a fine-grained feature point from the coarse-grained feature point.

2. The energy-efficient point cloud feature extraction method based on the FPGA according to claim 1, wherein in the step 103, the column index h is calculated according to a following formula:
$$h = arctan ( \frac{y}{x} ) / Δα ,$$
wherein Δα represents resolution of a rotation angle of the LiDAR.

3. The energy-efficient point cloud feature extraction method based on the FPGA according to claim 1, wherein in the step 201, a local plane curvature c of an i^{th} data point pᵢ in the point cloud matrix is calculated according to a following formula:
$$c = \frac{1}{\vert S \vert ‖ {p}_{i} ‖} ‖ {Σ}_{j ∈ S , j \neq i} ( {p}_{i} - {p}_{j} ) ‖ ,$$
wherein S represents a set of consecutive points adjacent to the pᵢ in a same row in the point cloud matrix. 4, The energy-efficient point cloud feature extraction method based on the FPGA according to claim 1, wherein in the step 201, the unreliable data point or the blocking point is filtered out by calculating a depth distance difference between each data point and an adjacent point.

5. The energy-efficient point cloud feature extraction method based on the FPGA according to claim 1, wherein in the step 202, the slope θ is obtained by dividing a square of a distance difference between a current data point and a next laser wire harness in a z direction by a square of a horizontal projection distance between two points, and when a slope of a data point (x_{(i,j)}y_{(i,j)}, z_{(i,j)}) in a position (i,j) in the point cloud matrix is θ_{(i,j)},
$${θ}_{( i , j )} = \frac{{( {x}_{( i + 1 , j )} - {z}_{( i , j )} )}^{2}}{{( {x}_{( i + 1 , j )} - {x}_{( i , j )} )}^{2} + {( {y}_{( i + 1 , j )} - {y}_{( i , j )} )}^{2}} .$$

6. The energy-efficient point cloud feature extraction method based on the FPGA according to claim 1, wherein in the step 3, a plane point priority queue and a corner point priority queue are established based on the coarse-grained plane point and the coarse-grained corner point respectively, and elements in the plane point priority queue and the corner point priority queue form the fine-grained feature point, wherein
when nₑ fine-grained feature corner points are required, nₑ elements are stored in the corner point priority queue, the coarse-grained corner point is arranged in the corner point priority queue by curvature in a descending order, and elements whose column index difference is less than a preset value are not allowed to coexist in the corner point priority queue; and
when nₚ fine-grained plane points are required, nₚ elements are stored in the plane point priority queue, the coarse-grained plane point is arranged in the plane point priority queue by, curvature in an ascending order, and elements whose column index difference is less than the preset value are not allowed to coexist in the plane point priority queue.

7. A method of an application of the energy-efficient point cloud feature extraction method based on the FPGA according to claim 1, comprising: applying the energy-efficient point cloud feature extraction method based on the FPGA to point cloud feature extraction in unmanned. driving or an intelligent robot.
